(19) United States
(12) Patent Application Publication
(10) Pub. No.: US 2016/0046473 A1
(43) Pub. Date: Feb. 18, 2016

(54) Bottle Opening Device

(71) Applicants: Keith Jordan, State College, PA (US); Kyle Jordan, State College, PA (US)

(72) Inventors: Keith Jordan, State College, PA (US); Kyle Jordan, State College, PA (US)

(21) Appl. No.: 14/933,546

(22) Filed: Nov. 5, 2015

Related U.S. Application Data
(63) Continuation-in-part of application No. 29/488,578, filed on Apr. 21, 2014, now abandoned.
(60) Provisional application No. 62/075,836, filed on Nov. 5, 2014.

(51) Int. Cl. B67B 7/16; A63B 43/00

(52) U.S. Cl. CPC B67B 7/16; A63B 43/002

(57) ABSTRACT

A bottle opening device includes a sports projectile and an insert. The sports projectile has an outer surface and a cavity extending into the outer surface. The cavity is defined at least partially by a bearing surface of the sports projectile. The insert has an opening that extends through the insert and between a first face surface and an opposing second face surface of the insert. The insert is received within the cavity of the sports projectile such that (i) the first face surface of the insert engages the bearing surface of the sports projectile and (ii) the second face surface of the insert is at least substantially flush with the outer surface of the sports projectile in an area adjacent to the cavity.

### CROSS-REFERENCE TO RELATED APPLICATIONS

This application claims priority to U.S. Design Patent Application No. 29/488,578, filed Apr. 21, 2014, and U.S. Provisional Patent Application No. 62/075,836, filed Nov. 5, 2014, the contents of which are incorporated herein by reference.

### FIELD OF THE INVENTION

The present disclosure relates generally to a bottle opening device, and more particularly to a bottle opening device that includes or is incorporated into another object that has one or more alternative purposes.

### BACKGROUND OF THE INVENTION

It is known to provide a bottle opening device for removing metal caps from bottles. In some instances, a bottle opening device can also include corkscrews or related tools for the removal of corks or plastic stoppers from bottles (e.g., wine bottles). A known problem in the art is that users often find themselves in situations where they have bottles requiring a bottle opening device, but there is no bottle opening device readily available.

One way the prior art has addressed this problem is by making the bottle opening device in a key chain form or another form that is small and can easily be kept on one's person. However, many people do not want to carry a bottle opening device around with them all the time, or they need a bottle opening device during activities where it is impractical to have keys or a standard bottle opening device on their person (e.g., during sports activities).

Another way the prior art has addressed this problem is by providing a bottle opening device in combination with another object that has one or more alternative purposes. For example, bottle opening devices have been incorporated into a grilling spatula, or embedded in the sole of a sandal. Thus, when a user is grilling with such a spatula, or wearing such a sandal, a bottle opening device will be readily available if the situation arises that a bottle opening device is needed.

In some instances, a bottle opening device has been incorporated into sporting equipment. However, in such instances, the bottle opening device has not been incorporated into the sporting equipment in such a way as to maintain the utility of the sporting equipment for use in the sport for which it was originally intended.

Aspects of the present invention are directed to these and other problems.

### SUMMARY OF THE INVENTION

According to an aspect of the present invention, a bottle opening device includes a sports projectile and an insert. The sports projectile has an outer surface and a cavity extending into the outer surface. The cavity is defined at least partially by a bearing surface of the sports projectile. The insert has an opening that extends through the insert and between a first face surface and an opposing second face surface of the insert. The insert is received within the cavity of the sports projectile such that (i) the first face surface of the insert engages the bearing surface of the sports projectile and (ii) the second face surface of the insert is at least substantially flush with the outer surface of the sports projectile in an area adjacent to the cavity.

According to another aspect of the present invention, a bottle opening device includes a hockey puck and an insert. The hockey puck has an outer surface and a cavity extending into the outer surface. The cavity is defined at least partially by a bearing surface of the hockey puck. The insert has an opening that extends through the insert and between a first face surface and an opposing second face surface of the insert. The insert is received within the cavity of the hockey puck such that (i) the first face surface of the insert engages the bearing surface of the hockey puck, (ii) the second face surface of the insert is at least substantially flush with the outer surface of the hockey puck in an area adjacent to the cavity, and (iii) the insert is positionally fixed relative to the cavity via one or more screws.

According to another aspect of the present invention, a bottle opening device includes a sports projectile and an insert. The sports projectile has an outer surface and a cavity extending into the outer surface. The cavity is defined at least partially by a bearing surface of the sports projectile. The insert has an opening that extends through the insert and between a first face surface and an opposing second face surface of the insert. The insert is received within the cavity of the sports projectile such that (i) the first face surface of the insert engages the bearing surface of the sports projectile and (ii) the second face surface of the insert is coplanar or inset with the outer surface of the sports projectile in an area adjacent to the cavity.

In addition to, or as an alternative to, one or more of the features described above, further aspects of the present invention can include one or more of the following features, individually or in combination:
a portion of the cavity is exposed through the opening of the insert when the insert is received within the cavity;
the outer surface of the sports projectile in an area adjacent to the cavity defines a first plane, the insert and the cavity define respective cross-sectional shapes, when viewed in a second plane that is perpendicular to the first plane, that correspond with one another;
the outer surface of the sports projectile in an area adjacent to the cavity defines a first plane, the insert and the cavity define respective cross-sectional shapes, when viewed in a second plane that is parallel to the first plane, that correspond with one another;
the sports projectile is a hockey puck;
the outer surface is substantially flat in the area adjacent to the cavity;
the sports projectile is made of vulcanized rubber;
the cavity includes a first cavity area and a second cavity area that each have a cylindrical shape and are concentrically aligned relative to one another;
a depth of the first cavity area is less than a depth of the second cavity area;
a width of the first cavity area is less than a width of the second cavity area;
the insert is operable to be used to remove a bottle cap from a bottle;
the insert is positionally fixed relative to the cavity via an interference fit; and
the insert is positionally fixed relative to the cavity via one or more attachment members.

These and other aspects of the present invention will become apparent in light of the drawings and detailed description provided below.

### BRIEF DESCRIPTION OF THE DRAWINGS

The above and other aspects, features and advantages of certain embodiments of the present invention will be more apparent from the following detailed description taken in conjunction with the accompanying drawings, in which:

FIG. 1 illustrates a perspective view of a bottle opening device.

FIG. 2 illustrates an exploded perspective view of the bottle opening device of FIG. 1.

FIG. 3 illustrates a partial cross-sectional elevation view of the bottle opening device of FIG. 1.

FIG. 4 illustrates a partial cross-sectional elevation view of the bottle opening device of FIG. 1 during operation.

FIG. 5 illustrates a partial cross-sectional elevation view of another bottle opening device.

While the invention is described with reference to the above drawings, the drawings are intended to be illustrative, and the invention contemplates other embodiments within the spirit of the invention.

### DETAILED DESCRIPTION OF THE INVENTION

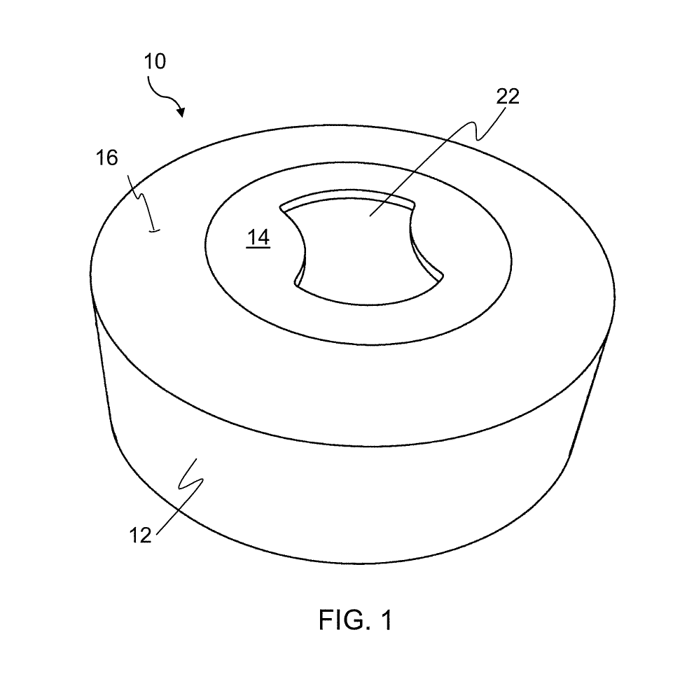

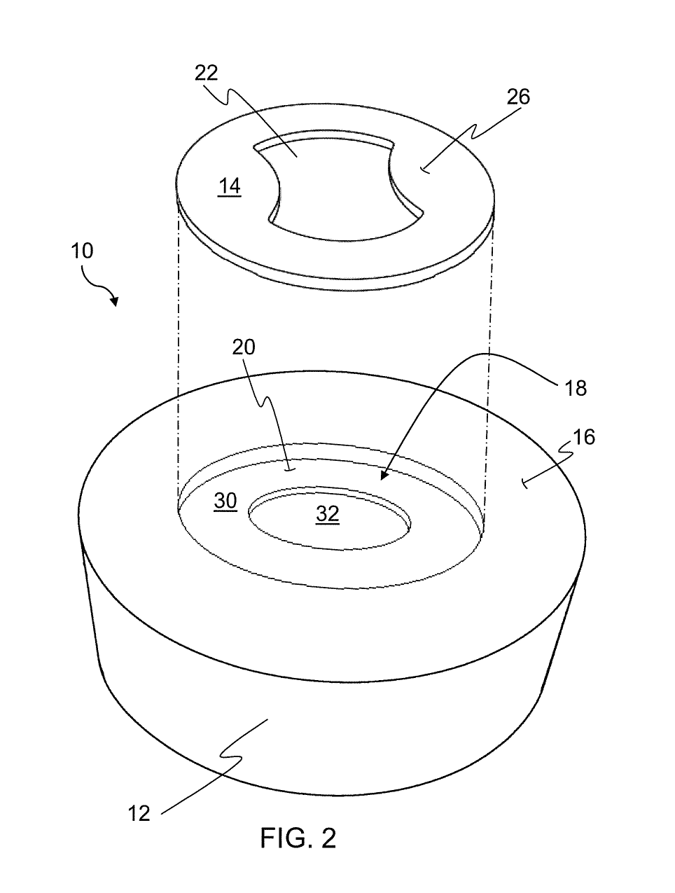

Referring to FIGS. 1-5, the present disclosure describes a bottle opening device 10. The bottle opening device 10 includes a sports projectile 12 and an insert 14. The sports projectile 12 has an outer surface 16 and a cavity 18 extending into the outer surface 16. The cavity 18 is defined at least partially by a bearing surface 20 of the sports projectile 12. The insert 14 has an opening 22 that extends through the insert 14 and between a first face surface 24 and an opposing second face surface 26 of the insert 14. The insert 14 is received within the cavity 18 of the sports projectile 12 such that (i) the first face surface 24 of the insert 14 engages the bearing surface 20 of the sports projectile 12 and (ii) the second face surface 26 of the insert 14 is at least substantially flush with, coplanar with, or inset relative to the outer surface 16 of the sports projectile 12 in an area adjacent to the cavity 18. In the illustrated embodiments, a portion of the cavity 18 is exposed through the opening 22 of the insert 14.

The sports projectile 12 can take various different forms relating to the sport for which it is intended. In the illustrated embodiments, the sports projectile 12 is a standard-sized hockey puck having a diameter of 3 inches, a height of 1 inch, and a weight between 5.5 and 6 ounces. In other embodiments, the sports projectile 12 can be a baseball, golf ball, tennis ball, or some other sports projectile.

The outer surface 16 of the sports projectile 12 can have various different shapes in the area adjacent to the cavity 18. In the illustrated embodiments, the outer surface 16 is substantially flat in the area adjacent to the cavity 18. In other embodiments, the outer surface 16 can be curved, dimpled, ridged, or can take another shape in the area adjacent to the cavity 18. In other embodiments, the outer surface 16 can have one or more logos or designs printed thereon to allow a sports enthusiast to show their support for a particular sports team or to allow an organization to advertise their logo or brand.

The sports projectile 12 can be made of various different materials or combination of materials depending on the form of the sports projectile 12. In the illustrated embodiments, the sports projectile 12 is a hockey puck, and thus is made out of vulcanized rubber. In other embodiments in which the sports projectile 12 takes another form (e.g., baseball, golf ball, etc.), the sports projectile 12 can be made of other materials or combinations of materials that are typically used to make such sports projectiles.

The cavity 18 formed in the outer surface 16 of the sports projectile 12 can be configured in various different ways. In the illustrated embodiments, the cavity 18 includes a first cavity area 30 and a second cavity area 32 that each have a cylindrical shape and are concentrically aligned relative to one another. The first cavity area 30 has a depth 34 extending between (i) the bearing surface 20 of the sports projectile 12 and (ii) the plane defined by the outer surface 16 of the sports projectile 12 in an area adjacent to the cavity 18. The second cavity area 32 has a depth 36 extending between (i) another surface of the sports projectile 12 that defines the bottom of the cavity 18 and (ii) the plane defined by the outer surface 16 of the sports projectile 12 in an area adjacent to the cavity 18. The depth 34 of the first cavity area 30 is less than the depth 36 of the second cavity area 32. The first cavity area 30 has a width 40 extending between opposing surfaces of the sports projectile 12 that define the cavity 18, and the second cavity area 32 has a width 42 extending between opposing surfaces of the sports projectile 12 that define the cavity 18. The width 40 of the first cavity area 30 is greater than the width 42 of the second cavity area 32.

The cavity 18 can be part of the design of the sports projectile 12, or can be formed in the outer surface 16 of the sports projectile 12 via drilling, grinding, carving, cutting, laser cutting, 3D Printing, burning, stamping, or another technique that is known in the art.

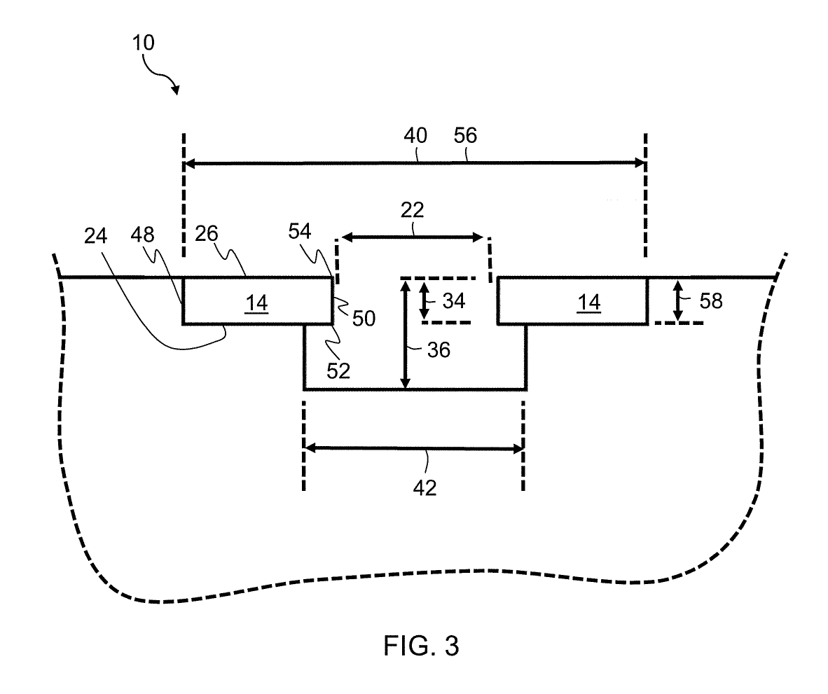

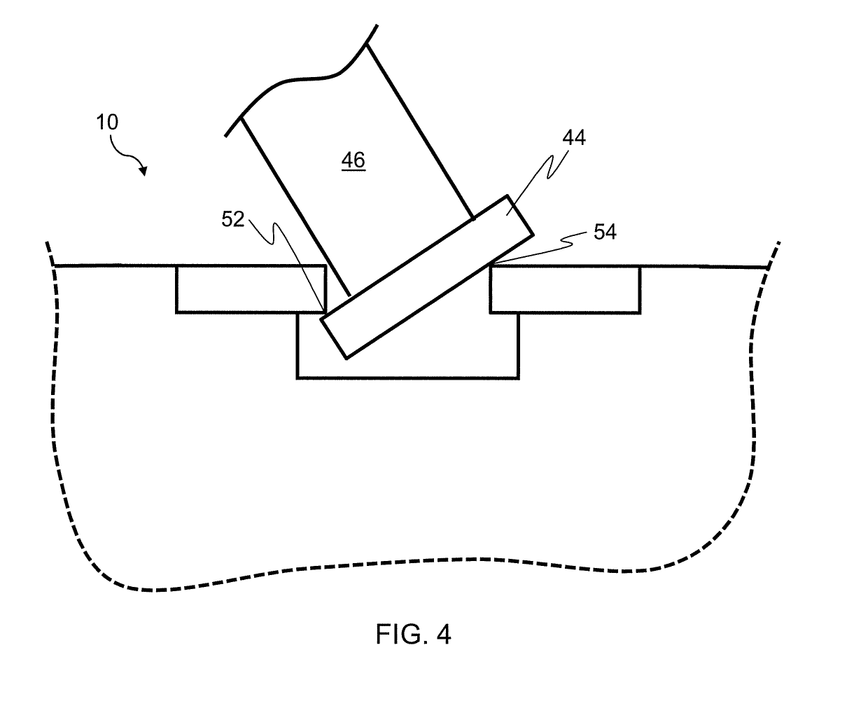

The insert 14 of the bottle opening device 10 serves as the structure that is used to remove a bottle cap 44 from a bottle 46 (see FIG. 4). The insert 14 can be configured in various different ways. Referring to FIG. 3, in the illustrated embodiments, the insert 14 is cylindrical and has an opening 22 that extends through the insert 14 between the first face surface 24 and the opposing second face surface 26, both of which are flat. The insert 14 also defines an outer side surface 48 that extends between first face surface 24 and the second face surface 26 and around the periphery of the insert 14, and an inner side surface 50 that extends between the first face surface 24 and the second face surface 26 to define the opening 22 extending through the insert 14. The insert 14 defines a first edge 52 where the first face surface 24 meets the inner side surface 50, and a second edge 54 where the second face surface 26 meets the inner side surface 50. The first edge 52 and the second edge 54 are both “sharp” edges. In other embodiments, the insert 14 can have: (i) a non-circular cross-sectional shape (e.g., triangular, rectangular, pentagonal, elliptical, etc.) when viewed in a plane parallel to the plane defined by the outer surface in an area adjacent to the cavity; (ii) a hollow body, with an opening that does not extend through the insert, but rather opens up into the hollow body of the insert; and/or (iii) edges that are at least slightly rounded rather than being “sharp.”

The opening 22 extending through the insert 14 can have various cross-sectional shapes when viewed in a plane parallel to the plane defined by the outer surface 16 in an area adjacent to the cavity 18. In the illustrated embodiments, the opening 22 has an hourglass cross-sectional shape. In other embodiments, the opening can have another cross-sectional shape that permits the insert to function for its intended purpose.

In some embodiments, the insert 14 is positionally fixed relative to the cavity 18 via an interference fit. In such embodiments, the insert 14 and the cavity 18 define respective cross-sectional shapes that correspond with one another. In the embodiment of FIGS. 1-4, the insert 14 is positionally fixed relative to the cavity 18 via an interference fit, and the insert 14 and cavity 18 define respective cross-sectional shapes that correspond to one another. Referring to FIG. 3, the insert 14 defines a width 56 that is substantially equal to, but slightly greater than the width 40 of the first cavity area 30, and the insert 14 defines a height 58 that is substantially equal to the depth 34 of the first cavity area 30.

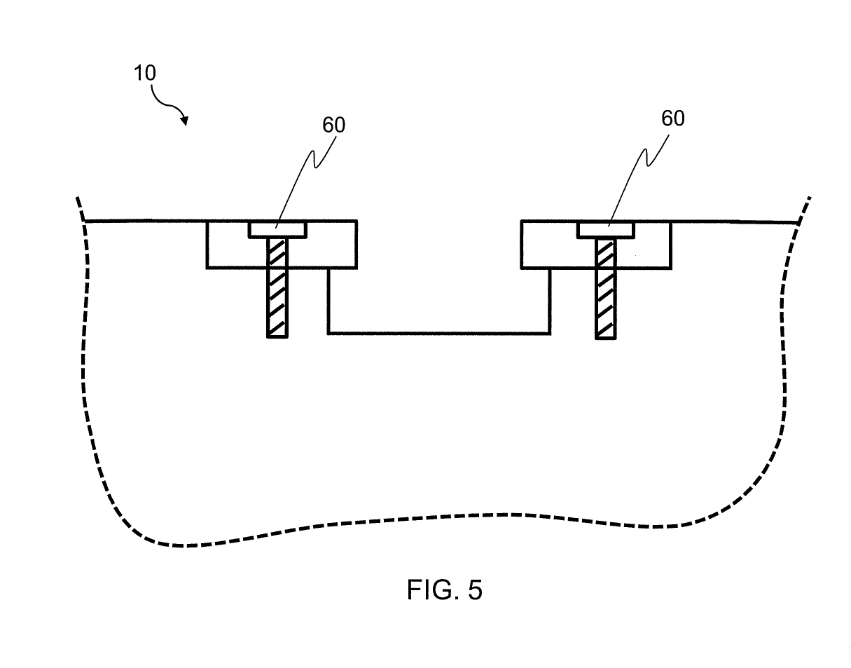

In some embodiments, the insert 14 is positionally fixed relative to the cavity 18 using one or more attachment devices. In the embodiment of FIG. 5, the insert 14 is positionally fixed relative to the cavity 18 via screws 60. In other embodiments, the insert 14 can be adhered to the sports projectile 12 via glue, other adhesive, hooks, tape, hook and loop fasteners, ridged/textured/scored surfaces molded into the insert 14 and/or the sports projectile 12, screws, nails, or other methods known in the art.

As indicated above, the insert 14 is configured such that a portion of the cavity 18 is exposed through the opening 22 when the insert 14 is received within the cavity 18. In some embodiments, the insert 14 includes one or more edges proximate the opening 22, and the edges can be engaged by a bottle cap 44 when the bottle cap 44 is inserted through the opening 22. In the illustrated embodiments, for example, the first edge 52 and the second edge 54 of the insert 14 can be engaged by a bottle cap 44 when the bottle cap 44 is inserted through the opening 22 as described below.

The insert 14 can be formed in many different ways, and using a variety of manufacturing methods. The insert 14 can be formed with grinding, carving, cutting, laser cutting, 3D Printing, burning, stamping, or other means. The insert 14 can be made from metal, plastic, rubber, wood, fiber glass, or other materials known in the art, or from a combination of those materials. In some embodiments, the insert 14 will be of a weight equal to the material removed from the sports projectile 12 in the process of forming the cavity 18, such that the total weight of the bottle opening device 10 is equal to the total weight of the standard, unmodified sports projectile from which the bottle opening device 10 was formed.

Referring to FIG. 4, during use of the bottle opening device 10, the first edge 52 or portion thereof will engage a bottle cap 44 on the bottom or ridged side of the bottle cap 44, while a second edge 54 engages the bottle cap 44 on the top or flat side of the bottle cap 44. Upon movement or rotation of the bottle opening device 10 relative to the bottle 46, the first edge 52 will create an upward force on the bottom or ridged side of the bottle cap 44, while the second edge 54 creates a downward force on the top or flat side of the bottle cap 44. Thus, the bottle cap 44 is lifted or torqued off of the bottle 46. Depending on the strength of the bottle cap 44 itself, the strength of the seal between the bottle cap 44 and the bottle 46, and other factors, the bottle cap 44 might be bent during its removal from the bottle 46.

The bottle opening device 10 offers several advantages over known bottle opening devices. Among other things, the bottle opening device 10 is formed from a sports projectile 12, and can be used for playing the sport for which the unmodified version of the sports projectile 12 is intended. By serving simultaneously as a projectile for a particular sport, and as an opener for bottles, the bottle opening device 10 addresses the problem of individuals finding themselves in situations where a bottle opener is needed but there is no bottle opener readily available. In particular, the bottle opening device 10 increases the availability of a bottle opener for participants in the sport for which the bottle opening device 10 is intended to be used. In the illustrated embodiments, the bottle opening device 10 can be used for playing hockey, or for opening bottles. Thus, individuals that use the bottle opening device 10 in the illustrated embodiment to play hockey will have a bottle opener readily available to them when the need for opening a bottle arises. In the illustrated embodiments, the second face surface 26 of the insert 14 is flush with the outer surface 16 of the sports projectile 12 in an area adjacent to the cavity 18, thus allowing the bottle opening device 10 to slide along the ice much the same as an unmodified hockey puck would. In some embodiments, the insert 14 will be of a weight equal to the material displaced by the cavity 18, creating a bottle opening device 10 with a weight equal to the standardized weight of an unmodified sports projectile from which the bottle opening device 10 was formed, thus allowing the bottle opening device 10 to respond to a pass or shot in substantially the same way as an unmodified sports projectile would respond.

While several embodiments have been disclosed, it will be apparent to those of ordinary skill in the art that aspects of the present invention include many more embodiments and implementations. Accordingly, aspects of the present invention are not to be restricted except in light of the attached claims and their equivalents. It will also be apparent to those of ordinary skill in the art that variations and modifications can be made without departing from the true scope of the present disclosure. For example, in some instances, one or more features disclosed in connection with one embodiment can be used alone or in combination with one or more features of one or more other embodiments.

What is claimed is:

1. A bottle opening device, comprising:
a sports projectile having an outer surface and a cavity extending into the outer surface, the cavity being defined at least partially by a bearing surface of the sports projectile;
an insert having an opening, the opening extending through the insert and between a first face surface and an opposing second face surface of the insert;
wherein the insert is received within the cavity of the sports projectile such that (i) the first face surface of the insert engages the bearing surface of the sports projectile and (ii) the second face surface of the insert is at least substantially flush with the outer surface of the sports projectile in an area adjacent to the cavity.

2. The bottle opening device of claim 1, wherein a portion of the cavity is exposed through the opening of the insert when the insert is received within the cavity.

3. The bottle opening device of claim 1, wherein the outer surface of the sports projectile in an area adjacent to the cavity defines a first plane, the insert and the cavity define respective cross-sectional shapes, when viewed in a second plane that is perpendicular to the first plane, that correspond with one another.

4. The bottle opening device of claim 1, wherein the outer surface of the sports projectile in an area adjacent to the cavity defines a first plane, the insert and the cavity define respective cross-sectional shapes, when viewed in a second plane that is parallel to the first plane, that correspond with one another.

5. The bottle opening device of claim 1, wherein the sports projectile is a hockey puck.

6. The bottle opening device of claim 1, wherein the outer surface is substantially flat in the area adjacent to the cavity.

7. The bottle opening device of claim 1, wherein the sports projectile is made of vulcanized rubber.

8. The bottle opening device of claim 1, wherein the cavity includes a first cavity area and a second cavity area that each have a cylindrical shape and are concentrically aligned relative to one another.

9. The bottle opening device of claim 8, wherein a depth of the first cavity area is less than a depth of the second cavity area.

10. The bottle opening device of claim 8, wherein a width of the first cavity area is less than a width of the second cavity area.

11. The bottle opening device of claim 1, wherein the insert is operable to be used to remove a bottle cap from a bottle.

12. The bottle opening device of claim 1, wherein the insert is positionally fixed relative to the cavity via an interference fit.

13. The bottle opening device of claim 1, wherein the insert is positionally fixed relative to the cavity via one or more attachment members.

14. A bottle opening device, comprising:
a hockey puck having an outer surface and a cavity extending into the outer surface, the cavity being defined at least partially by a bearing surface of the hockey puck;
an insert having an opening, the opening extending through the insert and between a first face surface and an opposing second face surface of the insert;
wherein the insert is received within the cavity of the hockey puck such that (i) the first face surface of the insert engages the bearing surface of the hockey puck, (ii) the second face surface of the insert is at least substantially flush with the outer surface of the hockey puck in an area adjacent to the cavity, and (iii) the insert is positionally fixed relative to the cavity via one or more screws.

15. A bottle opening device, comprising:
a sports projectile having an outer surface and a cavity extending into the outer surface, the cavity being defined at least partially by a bearing surface of the sports projectile;
an insert having an opening, the opening extending through the insert and between a first face surface and an opposing second face surface of the insert;
wherein the insert is received within the cavity of the sports projectile such that (i) the first face surface of the insert engages the bearing surface of the sports projectile and (ii) the second face surface of the insert is coplanar or inset with the outer surface of the sports projectile in an area adjacent to the cavity.
